(19) United States
(12) Patent Application Publication
(10) Pub. No.: US 2007/0162651 A1
(43) Pub. Date: Jul. 12, 2007

(54) Data transfer control

(75) Inventors: David John Gwilt, Cambridge (GB); Christopher Edwin Wrigley, Saffron Walden (GB)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 11/639,336

(22) Filed: Dec. 15, 2006

(30) Foreign Application Priority Data
Dec. 21, 2005 (GB) 0526003.9

(51) Int. Cl. G06F 13/28

(52) U.S. Cl. 710/22

(57) ABSTRACT

The application discloses a direct memory access controller operable to control data transfer between a plurality of data source and data destination pairs comprising: at least one port operable to receive data from at least one data source and to output data to at least one data destination; and a channel operable to transfer data between said at least some of said plurality of data source and data destination pairs, said channel comprising registers operable to store data transfer control data, said data transfer control data comprising a source address of said data to be transferred, a destination address of said data to be transferred and control data, said data source address and said data destination address specifying said data source and data destination; wherein prior to a data transfer between a data source and data destination pair said direct memory access controller is operable to request data transfer control data corresponding to said data source and data destination pair from a memory and to store said data transfer control data in said channel registers; and following suspension or completion of said data transfer said direct memory access controller is operable to output modified data transfer control data to said memory, such that said channel is operable to transfer data between different data source and data destination pairs in dependence upon data transfer control data received from said memory.

### BACKGROUND OF THE INVENTION

1. Field of the Invention

This invention relates to the field of the control of data transfer in data processing systems. More particularly, this invention relates to the field of direct memory access controllers.

2. Description of the Prior Art

Direct memory access (DMA) controllers are used to control the transfer of data between memory and other peripheral devices or between different memories without the data passing through the CPU. DMA controllers can have a plurality of control channels that are set up in hardware and that are used for data transfers between a data source and data destination. The channel can be seen as a data stream between a particular data source and data destination. In ARM (registered trade mark of ARM Cambridge, UK) PL080/PL081, each DMA channel is fully implemented in hardware, such that all state/storage relevant to a particular channel is immediately available. This required significant gatecount, some of which remains unused for much of the time, since it is unlikely that all channels will be active all of the time. Additionally bottlenecks within the DMA controller (e.g. a single bus interface unit) may mean that not all channels can be serviced simultaneously—they must be sequenced. Thus, even in the case where all channels are active, they are still quiescent whilst awaiting arbitration.

In some systems, particularly those having a lot of peripherals many channels may be required but as the peripherals may only require a low bandwidth and may be inactive much of the time, the channels may often not be used.

In some other known systems, some control channels may be dedicated to a particular device while other devices may be able to select a free channel to use. To initiate a data transfer between for example a peripheral device and memory, the peripheral device driver sets up one of the DMA channels and then transfers a burst of data that may consist of several data items using this control channel. Setting up a control channel is done in such systems by the CPU using a device driver to write the required context information to the channel registers. This clearly has a CPU usage overhead.

### SUMMARY OF THE INVENTION

A first aspect of the present invention provides a direct memory access controller operable to control data transfer between a plurality of data source and data destination pairs comprising: at least one port operable to receive data from at least one data source and to output data to at least one data destination; and a channel operable to transfer data between said at least some of said plurality of data source and data destination pairs, said channel comprising registers operable to store data transfer control data, said data transfer control data comprising a source address of said data to be transferred, a destination address of said data to be transferred and control data, said data source address and said data destination address specifying said data source and data destination; wherein prior to a data transfer between a data source and data destination pair said direct memory access controller is operable to request data transfer control data corresponding to said data source and data destination pair from a memory and to store said data transfer control data in said channel registers; and following suspension or completion of said data transfer said direct memory access controller is operable to output modified data transfer control data to said memory, such that said channel is operable to transfer data between different data source and data destination pairs in dependence upon data transfer control data received from said memory.

The ability to allocate a channel to a particular data source and data destination pair using data transfer control information corresponding to this data path, that can be read from a memory used and modified and then saved back to the memory, allows the DMA controller to allocate a channel to a particular data source and data destination pair in response to current data transfer requirements. This makes the system extremely flexible and avoids or at least impedes a channel being allocated and not being used and thereby increases the efficiency of the gate usage. Thus, a reduced gatecount can be achieved for the same number of channels, or a greater number of channels can effectively be provided for the same gatecount. It should be noted that a data source data destination pair, are simply the data source and data destination that data is to be transferred between at a particular time. Thus, a particular data source may form a pair with many data destinations and vice versa. Furthermore, a data source in a particular data transfer may become a data destination in a different data transfer. In a similar way, the at least one port for receiving and outputting data may include a single port for receiving and outputting data, and/or there may be a plurality of ports, with at least some of them being dedicated as an input port or an output port.

Preferably, said direct memory access controller comprises a data store operable to store identifiers identifying storage locations of said data transfer control data for data transfers between respective data source and data destination pairs within said memory.

Although, by storing the context of the channels in a memory outside of the DMA controller storage space within the DMA controller is reduced, some of this saving is offset by the need to store identifiers identifying the storage locations of the data transfer control data corresponding to each of the channels within this external memory. However, an advantage of storing these identifiers within the DMA controller is that it enables it to access the required context information in a simple and straightforward fashion.

In some embodiments, the identifiers may comprise the addresses of the data transfer control data within the memory, while in others said identifiers comprise at least one base address and at least one offset to said at least one base address.

Using a base address which is, for example, the address of the base of the virtual channel contexts with a given offset for each channel, reduces the amount of storage space required to store this data, while still enabling easy access to it.

In most embodiments, at least one of said at least one data source and at least one data destination comprises a memory and at least one of said at least one data source and at least one data destination comprises a peripheral.

In some embodiments the direct memory access controller comprises a plurality of data sources and a plurality of data destinations, wherein at least some of said data sources and data destinations comprise peripherals.

Peripherals often have a low bandwidth associated with their data transfer and are often not active for substantial lengths of time. Thus, they lend themselves well to the use of virtual channels during data transfer whereby a particular channel is not allocated for their use all of the time but can just be allocated as required.

In some embodiments one of said peripherals comprises one of said plurality of data sources and one of said plurality of data destinations.

Although a peripheral may just be a source or destination for data, many are able to both send and receive data and thus, during one particular data transfer may be the data source, while during another they may be the data destination.

In some embodiments, said direct memory access controller is operable to suspend a current data transfer in response to a signal requesting a further data transfer between a different data source and data destination pair, to output said modified current data transfer control data to said memory, and to receive data transfer control information relating to said further data transfer prior to proceeding with said further data transfer.

The ability to de-allocate a channel halfway through a data transfer enables a co-operative multitasking environment.

Preferably, said direct memory access controller is operable to continue with said current data transfer in response to said signal requesting said further data transfer until said direct memory access controller detects a yield signal relating to said current data transfer, said direct memory access controller being operable in response to said yield signal to suspend said current data transfer.

Yield signals within data transfers can be used to tell the DMA controller when it is safe to suspend a data transfer and allow another more urgent data transfer to proceed. This prevents or at least impedes data transfers from being halted at inappropriate moments and provides a system which allows data transfers to be suspended in an efficient manner.

Preferably, said channel comprises a further register operable to store said channel program counter.

A channel program counter register within the channel allows the DMA program execution to be restarted when the channel has completed its data transfer.

Preferably, the direct memory access controller comprises a plurality of channels each of said plurality of channels comprising respective registers for storing data transfer control data, said data transfer control data comprising a source address of said data to be transferred, a destination address of said data to be transferred and control data, said data source address and said data destination address specifying said data source and data destination.

The use of a plurality of channels each of which can be allocated to a particular data source/data destination pair enables a very flexible system which can allow data transfer between many different points without the need for too many channels.

Advantageously, the direct memory access further comprises a channel allocation register operable to store a plurality of indicators corresponding to said plurality of channels each indicating if said respective channel is allocated or not, said direct memory access controller being operable to select a channel for a data transfer in dependence upon said channel allocation register.

In order for the DMA controller to be able to select an appropriate channel, it needs to know which channels are free. This can be done in a simple yet elegant fashion by the use of a channel allocation register wherein the status of the particular channels can be simply represented. If no channels are free then the DMA may choose to suspend a particular data transfer, however, the provision of a channel allocation register means that it need only do this in the case that all channels are presently allocated.

In some embodiments, at least one of said plurality of channels is operable to transfer data between a particular predefined one of said plurality of data source data destination pairs.

It has been found to be advantageous in some embodiments to allocate a channel to a particular data source or data destination pair rather than allow it to be allocated on the fly. This can be particularly appropriate where data is often transferred between this particular pair and thus, the extra bus activity required to save and restore the channels and the extra time required to do this is not advantageous when compared to the small additional channel resource that is gained.

In some embodiments a channel can be allocated to a subset of the data source and data destination pairs whereas in others a channel is operable to transfer data between any of said plurality of data source and data destination pairs.

A further aspect of the present invention comprises a data processing apparatus comprising a direct memory access controller according to a first aspect of the present invention and a memory, said memory being operable to store data transfer control information relating to data transfers between particular data source and data destination pairs, said memory being in data communication with said direct memory access controller via a bus.

A yet further aspect of the present invention comprises a method of controlling data transfers between a plurality of data source and data destination pairs using a direct memory access controller comprising the steps of: in response to a signal requesting a data transfer between one of said plurality of data source and data destination pairs; requesting data transfer control data corresponding to said data source data destination pair from a memory; receiving said data transfer control data from said memory and storing said data transfer control data in registers of at least one channel; transferring data from said data source to said data destination using said at least one channel; outputting modified data transfer control data to said memory following completion or suspension of said data transfer. A still further aspect of the present invention provides a computer program product which is operable when run on a data processor to control the data processor to perform the steps of the method according to the yet further aspect of the present invention.

### BRIEF DESCRIPTION OF THE DRAWINGS

FIG. 1 schematically shows a data processing apparatus including a DMA controller according to an embodiment of the present invention;

FIG. 2 shows the timing of data transfer between the two channels of the DMA controller of FIG. 1;

FIG. 3 schematically shows a DMA controller and associated memory and peripherals of a further embodiment of the present invention; and

FIG. 4 shows a program thread of a program controlling a data transfer by the DMA controller.

### DESCRIPTION OF THE PREFERRED EMBODIMENTS

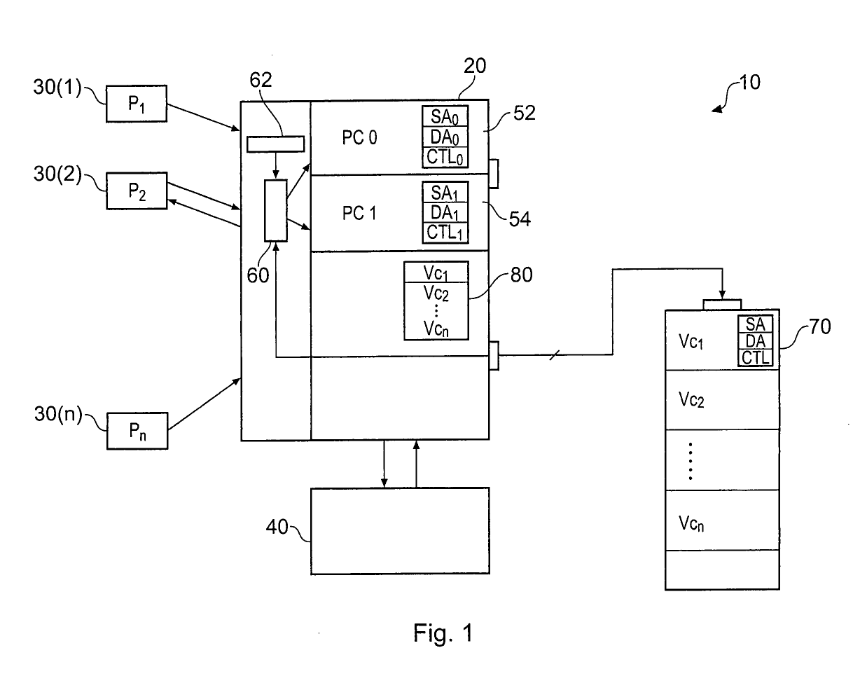

FIG. 1 schematically shows a data processing apparatus according to an embodiment of the present invention. The data processing apparatus 10 comprises a DMA (Direct Memory Access) controller 20 according to an embodiment of the present invention. The direct memory access controller 20 controls data transfers between the peripheral devices 30(1), . . . 30(n) and memory 40. Data transfer between these devices is performed by channels PC₀ or PC₁. A channel can be viewed as a single thread of operation comprising a sequence of instructions to set the parameters for one or more DMA transfers and to carry out those transfers.

During a data transfer, if the data source is a peripheral 30(1) . . . (n) DMA controller 20 receives a signal from the data source, indicating that it has data that it is ready to send to a specified data destination. It should be noted that if the data source is a memory, there is no need to send a signal to request data transfer. When the DMA controller 20 receives a signal from the specified data destination that it is ready to receive this data, the DMA controller 20 commences the necessary steps to transfer the data. It should be noted that if the data destination is a memory then no ready signal is sent or indeed required and the DMA controller will commence the necessary steps to transfer data immediately without waiting for such a signal.

In order to process a data transfer it needs to allocate one of the channels to this particular data source/data destination pair. Allocation logic 60 does this in conjunction with allocation register 62. Allocation logic 60 reads allocation register 62 to see if any channels are available. If one of the channels is available, allocation logic 60 allocates it to the appropriate data source and data destination pair. In order to do this, it requires the context information relating to this data source/destination pair and it accesses this from system memory 70. Memory 70 stores a plurality of what are in effect virtual channel context information. Each virtual channel relates to a particular data source and data destination pair. Thus, allocation logic 60 needs to access the appropriate address in memory 70 relating to the required data source data destination pair in order to allocate the selected channel to the required data source data destination pair.

Data store 80 within DMA controller 20 stores the locations of the virtual channels. Thus, allocation logic retrieves the locations, generally in the form of a base address and offset from data store 80 and accesses the context information in memory 70.

The context information comprises an address of the data to be read from the source, an address to which the data is to be written at the destination and control information. The control information comprises information about the data transfer such as burst length and data size. It may also comprise additional information such as cache control fields and protection control fields.

This context information is then loaded into the register 52, 54 of the selected channel. In some embodiments this information is in the form of three 32 bit words. Once this information is loaded in the channel PC₀ or PC₁ of the DMA controller 20, this channel is then ready to transfer data between the data source and data destination indicated.

It should be noted that as the locations of the virtual channels need to be stored in the DMA controller, an additional amount of state is required in the DMA controller. Thus, although the memory 70 can be used to store information about many channels, which thus does not need to be stored on the DMA controller except when the channel is being used, the locations of all this information does need to be stored. For example, there may be 32 possible data source/data destination pairs stored in the memory, thus their context information would amount to 32×3 32-bit words. In the DMA controller only two channels are allocated at one time thus, there are 6 32-bit words stored. However, the information concerning the location in the memory of the 32 different channels does need to be stored.

In order to reduce the amount of storage required in the DMA controller the information regarding the context of the virtual channels is stored in a particular way in the system memory so that it can be accessed without needing a pointer to each piece of data. This is done using a stack type of system which is described later.

It should be noted that the transfer of this context information between the system memory and DMA controller when allocating or deallocating a channel does have an overhead in bus activity.

When the data transfer is completed, then the data stored in the registers 52 54 of the selected channel are transferred back to the appropriate position in memory 70. The data stored in the registers will have been modified as data is written to and read from the destination and source. Furthermore, on commencement of the data transfer process, the allocation register is amended to indicate that the selected channel is busy. Following the data transfer, the allocation register is updated to indicate that this channel is once again free.

In some circumstances, allocation logic 60 will on accessing allocation register 62 find that none of the channels are available. In such a case, it will monitor the channels until it detects a “DMAyield” signal. This indicates that although a particular channel is in the process of transferring data from a data source to a data destination, it is at a point when it can be interrupted. Thus, this data transfer may be interrupted by downloading the value of the registers 52 or 54 into memory 70 and reading from memory 70 the information relating to the new data source and data destination. Thus, the new data transfer can go ahead. When it is finished, the information from the registers is downloaded back to memory 70 and the information corresponding to the previous data transfer is loaded back into this register and this data transfer can then be completed.

The stack or heap type system used for storage is as follows. The DMA controller comprises a DMA pointer, DST [31:0] which is a pointer indicating the location on system memory of the DMA channels that are inactive.

Each channel comprises a number of channel operation registers. These include a source address register, a destination address register, a channel control register, a loop 0 counter, a loop 0 program counter, a loop 1 counter and loop 1 program counter.

Stacked type channel register packing is done so the register file fits into between 4 and 6 32-bit words in memory. The memory format needs to be defined to enable the DMA hardware to stack and restore the contents on a thread switch.

The memory format regfile is as below. It should be noted that RS4 and RS5 corresponding to the two loop return program counter register only need to be loaded if the associated loop is active. The embodiment described is one where there are 32 virtual channels and 8 physical channels RS0 is the regfile stack zero, RS1 the regfile stack one and so on up to RS5 which is the regfile stack five. RS0 [31:0] comprises SAR[3 1:0], i.e. the location of the source address of the respective virtual channels. RS1[31:0] comprises DAR[31:0], i.e. the location of the destination address of the respective virtual channels. RS2[31:0] comprises CCR[31:0], i.e. the location of the control information of the respective virtual channels. RS3[15:8] is LC1[7:0] and RS3[7:0] is LC0[7:0]. This relates to the loop counter iterations of loops 0 and 1 of each program thread running on each of the eight actual channels that are present in this embodiment. RS4[3 1:0] comprises LPC0[3 1:0], and RS5 [31:0] comprises LPC1[31:0], i.e. the loop return program counters for loop 1 and loop 0 of the 32 virtual channels.

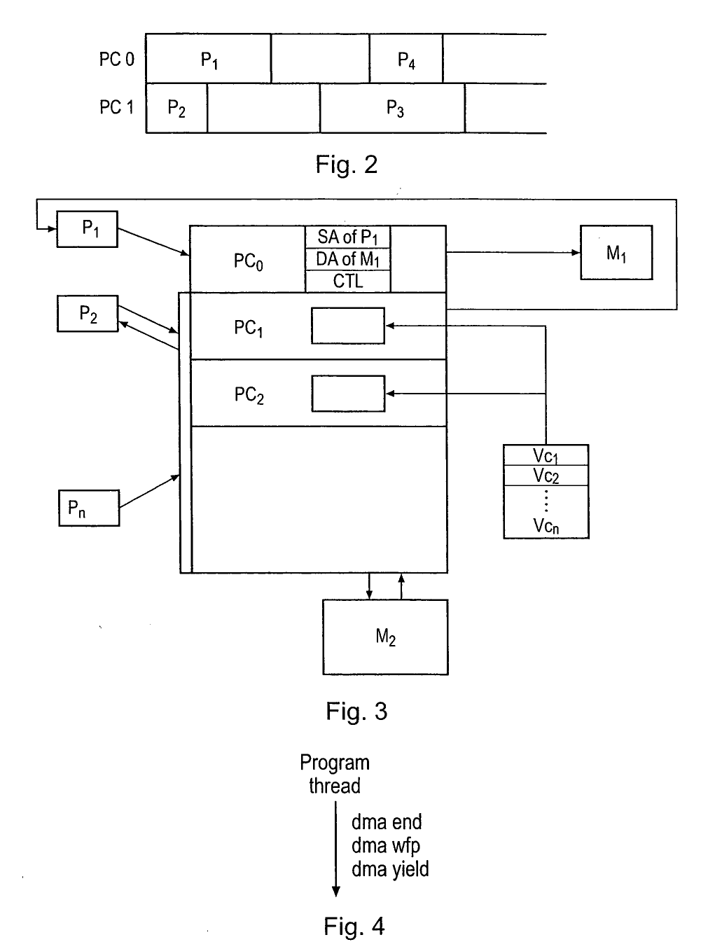

FIG. 2 show a timing diagram of data transfers using channels PC₀ and PC₁. As can be seen, they may not both be used all of the time.

FIG. 3 shows an alternative embodiment of the present invention, wherein one of the physical channels is pre-allocated to a particular peripheral and memory and the other channels are available to be allocated according to virtual channel information stored in memory 70. It may be that a particular peripheral and memory or two pieces of memory or in fact two peripherals transfer data between each other very often. In such cases, it may be advantageous to allocate them permanently to a particular channel. This is because although the use of virtual channels increases the number of channels that can be serviced without greatly increasing the gate count, it does have an impact on the timing of the device. Thus, if there is to be a lot of data transfer between particular places it may be advantageous in speed to pre-allocate one channel and not allow it to be allocated elsewhere.

FIG. 4 shows a program thread relating to the transfer of data. This thread controls the transfer and is part of the channel processing. It may contain a “dmawfp” instruction which is a “wait for peripheral” instruction, which means that the dma controller needs to provide a channel for the data transfer. As can be seen it may also include instructions such as “dmayield” which indicate that the data transfer can be interrupted at that point if another data source/data destination pair require the channel. If this occurs the channel data is stored back out to memory.

There may also be a manager thread which will fetch instructions from reset. These instructions can initiate a dma thread by storing a pc value into the channel storage (dmago instruction). The dma thread will then run until it comes to a dmaend instruction at which point it will stop fetching.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. A direct memory access controller operable to control data transfer between a plurality of data source and data destination pairs comprising:
(i) at least one port operable to receive data from at least one data source and to output data to at least one data destination; and
(ii) a channel operable to transfer data between said at least some of said plurality of data source and data destination pairs, said channel comprising registers operable to store data transfer control data, said data transfer control data comprising a source address of said data to be transferred, a destination address of said data to be transferred and control data, said data source address and said data destination address specifying said data source and data destination; wherein
(iii) prior to a data transfer between a data source and data destination pair said direct memory access controller is operable to request data transfer control data corresponding to said data source and data destination pair from a memory and to store said data transfer control data in said channel registers; and
(iv) following suspension or completion of said data transfer said direct memory access controller is operable to output modified data transfer control data to said memory, such that said channel is operable to transfer data between different data source and data destination pairs in dependence upon data transfer control data received from said memory.

2. A direct memory access controller according to claim 1, wherein said direct memory access controller comprises a data store operable to store identifiers identifying storage locations of said data transfer control data for data transfers between respective data source and data destination pairs within said memory.

3. A direct memory access controller according to claim 2, wherein said identifiers comprise at least one base address and at least one offset to said at least one base address.

4. A direct memory access controller according to claim 1, wherein at least one of said at least one data source and said at least one data destination comprise a memory and a peripheral.

5. A direct memory access controller according to claim 1, comprising a plurality of data sources and a plurality of data destinations, wherein at least some of said data sources and data destinations comprise peripherals.

6. A direct memory access controller according to claim 1, where one of said peripherals comprises one of said plurality of data sources and one of said plurality of data destinations.

7. A direct memory access controller according to claim 1, said direct memory access controller being operable to suspend a current data transfer in response to a signal requesting a further data transfer between a different data source and data destination pair, to output said modified current data transfer control data to said memory, and to receive data transfer control information relating to said further data transfer prior to proceeding with said further data transfer.

8. A direct memory access controller according to claim 7, said direct memory access controller being operable to continue with said data transfer in response to said signal requesting a further data transfer until said direct memory access controller detects a yield signal relating to said data transfer, said direct memory access controller being operable in response to said yield signal to suspend said data transfer.

9. A direct memory access controller according to claim 1, wherein said channel is operable to transfer data between any of said plurality of data source and data destination pairs.

10. A direct memory access controller according to claim 1, said channel comprising a further register operable to store said channel program counter.

11. A direct memory access controller according to claim 1, and further comprising a plurality of channels, each of said plurality of channels comprising respective registers for storing data transfer control data, said data transfer control data comprising a source address of said data to be transferred, a destination address of said data to be transferred and control data, said data source address and said data destination address specifying said data source and data destination.

12. A direct memory access controller according to claim 11, comprising a channel allocation register operable to store a plurality of indicators corresponding to said plurality of channels each indicating if said respective channel is allocated or not, said direct memory access controller being operable to select a channel for a data transfer in dependence upon said channel allocation register.

13. A direct memory access controller according to claim 11, wherein at least one of said plurality of channels is operable to transfer data between a particular predefined one of said plurality of data source data destination pairs.

14. A data processing apparatus comprising a direct memory access controller according to claim 1 and a memory, said memory operable to store data transfer control information relating to data transfers between particular data source data destination pairs, said memory being in data communication with said direct memory access controller via a bus.

15. A method of controlling data transfers between a plurality of data source and data destination pairs using a direct memory access controller comprising the steps of:
(i) in response to a signal requesting a data transfer between one of said plurality of data source and data destination pairs;
(ii) requesting data transfer control data corresponding to said data source data destination pair from a memory;
(iii) receiving said data transfer control data from said memory and storing said data transfer control data in registers of at least one channel;
(iv) transferring data from said data source to said data destination using said at least one channel;
(v) outputting modified data transfer control data to said memory following completion or suspension of said data transfer.

16. A method according to claim 15, wherein said step of requesting data transfer control data corresponding to said data source and data destination pair, comprises reading an identifier identifying a storage location of said data transfer control data of said pair from a data store within said direct memory access controller and accessing said storage location in said memory.

17. A method according to claim 15, wherein at least one of said at least one data source and at least one data destination comprises a memory.

18. A method according to claim 17, wherein at least one of said at least one data source and at least one data destination comprises a peripheral.

19. A method according to claim 15, said method comprising suspending said step of transferring data in response to a signal requesting a further data transfer between a different data source and data destination pair;
(i) outputting said modified suspended data transfer control data to said memory; and
(ii) receiving data transfer control information relating to said further data transfer and storing said further data transfer control data in registers of at least one channel;
(iii) transferring data from said different data source and data destination pair using said at least one channel.

20. A method according to claim 19, wherein said step of suspending said step of transferring data is only performed in response to a signal requesting a further data transfer between a different data source and data destination pair and a yield signal relating to said data transfer.

21. A method according to claim 15 wherein said direct memory access controller comprises a plurality of channels and said method comprises a further step of prior to requesting data transfer control data, reading a channel allocation register and selecting one of said plurality of channels that is free, and storing said data transfer control data in registers of said selected channel.

22. A computer program product which is operable when run on a data processor to control the data processor to perform the steps of the method according to claim 15.
